(19) United States
(12) Patent Application Publication
(10) Pub. No.: US 2012/0012648 A1
(43) Pub. Date: Jan. 19, 2012

(54) S/M for conducting a purchase transaction of eligible goods or services using a stored value

(76) Inventors: Samuel R. Collins, Woodstock, GA (US); Robert Skiba, Sandy Springs, GA (US); Mark Leonard, San Jose, CA (US)

(21) Appl. No.: 12/804,279

(22) Filed: Jul. 19, 2010

(51) Int. Cl. G06Q 50/00; G06F 17/00

(52) U.S. Cl. 235/375

(57) ABSTRACT

The present invention is directed to systems and methods of conducting a purchase transaction of eligible goods or services using a stored value associated with an indicia. Methods in accordance with the invention may include steps of: receiving at a point-of-sale identifiers of goods or services selected for purchase and the indicia; determining if the goods or services comprise eligible goods or services; totaling the amount required for the purchase of the eligible goods or services; determining if the stored value is sufficient for purchase of the eligible goods or services; using the stored value towards the purchase of the eligible goods or services; and using an additional funding source provided by the purchaser towards the purchase of any goods or services that are not eligible goods or services. Systems may include various communication interfaces, databases, and processing modules.

### BACKGROUND OF THE INVENTION

The present invention is generally directed to the use of a provided funded stored value card to provide payment for specifically approved goods or services. Specifically, the present invention is directed to a stored value card that is funded by a health care provider that may be used to provide payment towards approved medications (either prescription or over-the-counter (OTC) medications) at a retailer point-of-sale (POS).

A number of health care plans provide means for beneficiaries to purchase specifically approved goods, typically medications or other health related items. One such means is a health savings account (HSA), typically available through a health care provider, such as an insurance company or Medicare. Through such health care plans, a certain amount of funds may be available to purchase qualified goods or services, such as medications and health-related items. The amount of funds may be contributed by the user, or may be provided by the health care provider itself, such as in the case of Medicare, Part C.

Medicare Part C may provide, among other things, an amount of funds available to the beneficiary to purchase prescription or OTC medications. However, the process of using the funds from an HSA or Medicare Part C are often inconvenient, difficult, and inefficient for both the customer and the retailer who is selling the covered goods or services to the customer.

In many systems, a customer who selects an OTC medication or other covered item must make the purchase at the pharmacy counter, and such purchase transaction may not include other, non-covered items or medications. As retailers grow into more of a single-stop shopping facility (e.g., Wal-Mart which may offer a pharmacy, department store items, grocery store items, and other goods or services), forcing a consumer to make two (2) purchase transactions at a single retailer is highly inefficient and inconvenient.

At the pharmacy, the point-of-sale system or terminal may access a table issued by the relevant health care provider that lists covered items. The table may contain a stock-keeping unit (SKU) for each covered item, and this SKU may then be accessed in order to conduct the purchase transaction. Typically, only the pharmacy POS has access to the SKU tables issued by the health care providers.

Accordingly, there is a need to provide a system and method that allows consumers to purchase medications (OTC and/or prescription) and other goods or services covered by their health care provider in-lane along with other goods or services. A method of accepting funding from HAS plans for part of a purchase transaction, while accepting funding from an alternative source for non-covered goods or services is desired.

### SUMMARY OF THE INVENTION

Aspects of the invention may include a method of conducting a purchase transaction of goods or services, the goods or services which may comprise eligible goods or services, the purchase transaction funded at least in part by a stored value associated with an indicia presented by a purchaser at a point-of-sale, the stored value being redeemable towards the purchase of the eligible goods or services, the method which may comprise: receiving at a point-of-sale: (i) identifiers of goods or services selected for purchase; and (ii) the indicia associated with a stored value; determining if the goods or services selected for purchase comprise eligible goods or services; totaling the amount required for the purchase of the eligible goods or services; determining if the stored value associated with the indicia is sufficient for purchase of the eligible goods or services; upon positive determinations that the goods or services comprise eligible goods or services and that the stored value is sufficient for purchase of the eligible goods or services, using the stored value towards the purchase of the eligible goods or services; and using an additional funding source provided by the purchaser towards the purchase of any goods or services that are not eligible goods or services.

Other aspects of the invention may include a method of conducting a purchase transaction of goods or services, the goods or services which may comprise eligible goods or services, the purchase transaction funded at least in part by a stored value associated with an indicia presented by a purchaser at a point-of-sale, the stored value being redeemable towards the purchase of the eligible goods or services, the method being conducted by a computerized processor and comprising: receiving the indicia from the point-of-sale; accessing database records associated with the indicia, the ‘database records comprising eligible goods or services for the indicia and the amount of value associated with the indicia; receiving identifiers of goods or services selected for purchase; determining if the goods or services selected for purchase comprise eligible goods or services; determining a total amount of value required for the purchase of the eligible goods or services; if the amount of value associated with the indicia is less than the total amount of value required for the purchase of the eligible goods or services, informing point-of-sale of the deficiency and authorizing the purchase transaction for the amount of value associated with the indicia; if the amount of value associated with the indicia is greater than or equal to the total amount of value required for the purchase of the eligible goods or services, authorizing the purchase transaction for the total amount of value required to purchase the eligible goods or services; and following confirmation of the purchase transaction, reducing the amount of value associated with the indicia by the amount of value used in the purchase transaction.

Other aspects of the invention may include a computerized processor system for conducting a purchase transaction of goods or services facilitated, the goods or services which may comprise eligible goods or services, the purchase transaction funded at least in part by a stored value associated with an indicia presented by a purchaser at a point-of-sale, the stored value being redeemable towards the purchase of the eligible goods or services, the computerized processor system comprising: (A) a point-of-sale communication interface that provides selectable communication between the processor system and the point-of-sale, the point-of-sale interface configured to receive from the point-of-sale: (i) the indicia presented by the purchaser at the point-of-sale; and (ii) identifiers of goods or services selected for purchase; (B) a provider communication interface that provides selectable communication between the processor system and a provider, the provider determining which goods or services qualify as eligible goods or services, the provider communication interface configured to receive from the provider information sufficient to identify goods or services that qualify as eligible goods or services; (C) a database comprising records for each indicia, the records comprising value information pertaining to the value associated with the indicia; and (D) a processing module, the processing module coupled to the point-of-sale interface, provider communication interface, and database, the processing module configured to: (i) determine if the goods or services selected for purchase comprise eligible goods or services; (ii) total the amount required for the purchase of the eligible goods or services; (iii) determine if the stored value associated with the indicia is sufficient for purchase of the eligible goods or services; and (iv) upon positive determinations that the goods or services comprise eligible goods or services and that the stored value is sufficient for purchase of the eligible goods or services, provide the stored value to the point-of-sale towards the purchase of the eligible goods or services.

These and other aspects will become apparent from the following description of the invention taken in conjunction with the following drawings, although variations and modifications may be effected without departing from the spirit and scope of the novel concepts of the invention.

### BRIEF DESCRIPTION OF THE DRAWING

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates a method in accordance with some embodiments of the present invention for the purchase of covered goods or services from a retailer POS.

FIG. 2 illustrates a method in accordance with some embodiments of the present invention for the purchase of covered goods or services from a retailer POS.

FIG. 3 illustrates an exemplary database entry in accordance with some embodiments of the present invention for the purchase of covered goods or services from a retailer POS.

FIG. 4 illustrates a method in accordance with some embodiments of the present invention for the purchase of covered goods or services from a retailer POS.

FIG. 5 illustrates a method in accordance with some embodiments of the present invention for the purchase of covered goods or services from a retailer POS.

FIG. 6 illustrates a method in accordance with some embodiments of the present invention for the purchase of covered goods or services from a retailer POS.

FIG. 7 illustrates a system in accordance with some embodiments of the present invention for the purchase of covered goods or services from a retailer POS.

FIG. 8 illustrates a system in accordance with some embodiments of the present invention for the purchase of covered goods or services from a retailer POS.

FIG. 9 illustrates a system in accordance with some embodiments of the present invention for the purchase of covered goods or services from a retailer POS.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular. Reference figures preceded with “S” (e.g., S100) indicates a step.

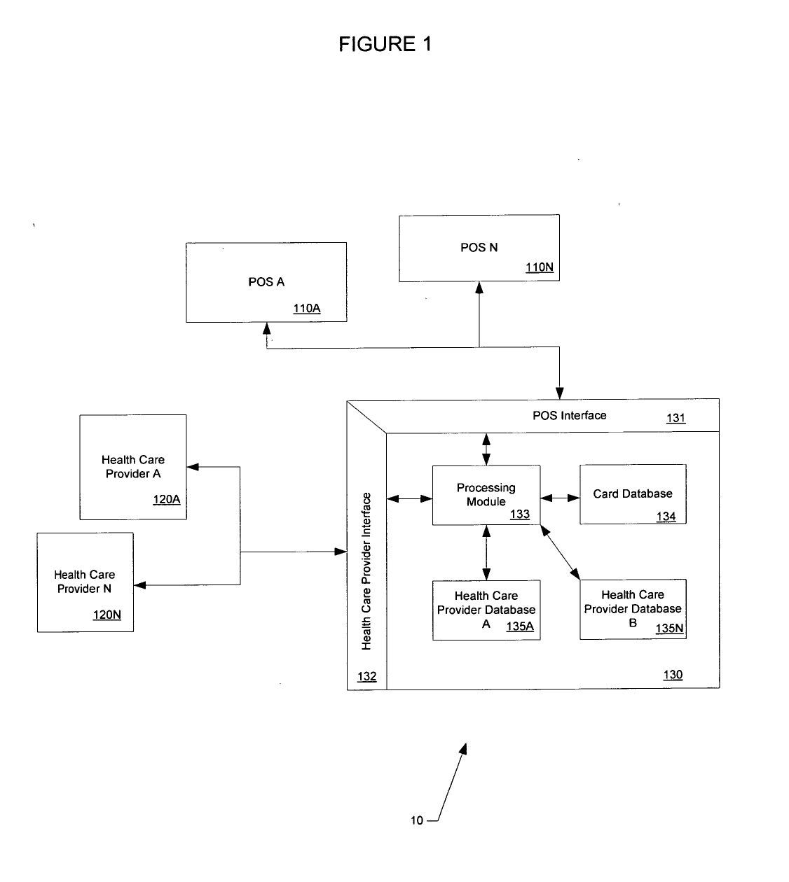

In general, the present invention is directed to systems and methods conducted between a customer, who may be a beneficiary of a HSA (or may be the representative of a beneficiary of a HSA), a merchant, a health care provider, and a processor. With reference to FIG. 1, a system 10 in accordance with some embodiments of the present invention may comprise one or more point-of-sale (POS) devices or locations 110A, 110N; one or more health care providers 120A, 120N, and a processor 130.

The POS devices or locations 110A, 110N may comprise any location, establishment, device, terminal, kiosk, or computer which conducts point-of-sale transactions. POS devices or locations 110A, 110N may be specifically identified—such as terminal 2837581 at Merchant ABC, or may be identified by varying levels of groups, merchants, or locations. For example, all terminals at Merchant XYZ may be considered as one for authorization and transaction purposes. Similarly, all terminals at Merchant XYZ in particular location may be considered as one, or alternatively terminals 1345, 9557, and 8647 may be specifically assigned to a group that is considered as one. In other words, POS devices or locations 110A, 110N may be authorized to conduct purchase transactions of covered goods or services as discussed below in varying, and potentially overlapping groups.

Health care provider 120A, 120N may be any entity that determines what goods or services are covered by a beneficiary's plan (“covered goods or services”), and/or any entity that provides, funds, or controls the spending of funds available for covered goods or services. Covered goods or services may differ from health care provider to health care provider, as well as beneficiary to beneficiary—often depending on the beneficiary's insurance plan, contributions, deductible, and other such factors well known in the art of insurance. Additionally, plans may provide for full coverage of some goods or services and only partial coverage of other goods or services. For example, OTC medication ABC may be eligible for full coverage (provided the beneficiary has sufficient value in his or her associated account), while OTC medication XYZ may be eligible only for 50% coverage, and the beneficiary may be required to provide payment for the non-covered 50% out-of-pocket from other funding sources. Similarly, particular merchants or services may be “in network” or “out of network,” and the coverage of a beneficiary's plan may vary accordingly.

The processor 130 may comprise a POS interface 131, a health care provider interface 132, a processing module 133, a card database 134, and one or more health care provider databases 135A, 135N. The POS interface 131 may handle all incoming and outbound communications with the one or more POS devices or locations 110A, 110N. Because each POS device or location 110A, 110N may have different system, authorization, or authentication requirements (e.g., different APIs), the POS interface 131 may collectively identify a plurality of interfaces with different POS devices or locations.

The health care provider interface 132 may handle all incoming and outbound communications with the one or more health care providers 120A, 120N. Because each health care provider 120A, 120N may have different system, authorization, or authentication requirements (e.g., different APIs), the health care provider interface 132 may collectively identify a plurality of interfaces with different health care providers.

The processing module 133 may perform the processing steps necessary to perform the purchase transaction of covered goods or services. The processing module 133 may be in selective communication with both the POS interface 131 and the health care provider interface 132, as well as with a the card database 134 and health care provider databases 135A, 135N. The card database 134 may comprise records related to a stored value card provided to a beneficiary.

The stored value card that may be provided to the beneficiary may have an associated account that is funded by another party, such as the health care provider, Medicare, or even the beneficiary's own HSA. Funds may be deposited into the account associated with the stored value card periodically (e.g., monthly, quarterly, yearly), or may be deposited in a lump sum. Funds may be accessible by the beneficiary immediately, or may be gradually released to the beneficiary periodically (e.g., monthly, quarterly, yearly) for use.

The stored value card may be of any physical shape, size, and configuration, and may comprise any type of material (e.g., plastic, cardboard, etc.). In some embodiments, the stored value card may resemble a standard debit or credit card, made of plastic and having the same or similar proportions or features. However, the stored value card may have different shapes, sizes, and configurations, such as a keychain card, folding paper card, metal, card, key-fob, software enabled figure on a smart phone, radio frequency identification (RFID) tag, or even a digital indicia (such as a bar code) that may be displayed on a portable electronic device (such as a mobile communications device).

The stored value card may be issued by the health care provider, processor, or a merchant. The stored value card may include machine readable indicia, such as a bar code, magnetic stripe, or RFID tag which may be read by a POS device or location 110. In some embodiments, the stored value card may have a machine readable indicia, into which is encoded a particular series of characters. This series of characters may be accessed by the POS device or location and used to properly route, authorize, and conduct purchase transactions.

In order to properly route transactions, the series of characters encoded, printed, or stored on the stored value card may comprise an issuer identification number, or IIN. Typically the IIN is six (6) characters, although in some embodiments the IIN may have a greater or fewer number of characters. The characters encoded, printed, or stored on the stored value card may comprise an identification of a health care provider, or even a specific health care provider plan. The characters encoded, printed, or stored on the stored value card may also comprise an individual card identifier which would identify each specific card. The characters encoded, printed, or stored on the stored value card may also comprise a checksum, such as one generated using the well-known Luhn Algorithm (e.g., a Mod10 digit) or any other type of checksum.

For example, in some embodiments the stored value card may include a nineteen (19) digit encoded series of characters. These nineteen (19) digits may comprise: a six (6) digit IIN; a two (2) digit provider identification number; a single digit placeholder for future use, an eight (8) digit randomly generated number that identifies the individual card; and a single digit checksum. Of course, the particulars of the encoded characters may differ in composition, length, and information, as known to one of ordinary skill in the art.

In some embodiments, the stored value card may include identifying information of the beneficiary, such as the beneficiary's name, date of birth, or health care plan number. The stored value card may further include additional information if so required or desired by the issuing party. Additional information may include logos, information regarding usage, telephone numbers or websites for additional assistance, and/or any other relevant or useful information.

The card database 134 may comprise a database entries or records related to each stored value card. These records may comprise identification of the health care provider, plan particulars, available value, replenishment cycles, and/or any other information related to the value, the card, the beneficiary, or the health care plan. In some embodiments, the card database may only provide information about the associated account of the stored value card. In such embodiments, the card database may simply maintain an available balance for each stored value card. Additionally, the card database may comprise information setting forth which POS devices or locations are authorized to conduct transactions with the stored value card.

The health care provider database 135A, 135N may include information regarding each associated health care provider, such as specific information about each health care plan available to beneficiaries. Such information may include plan details for each beneficiary, including selected optional plan riders (such as dental or maternity benefits), approved OTC or prescription medications, and funding cycles and/or amounts.

In accordance with some embodiments, the card database 134 and the health care provider database 135A, 135N may be combined into a single database accessible by the processing module 133. Such a single database may include actual records that may be found in the card or health care provider database, or may include active links directly to such external databases, but thereby providing the processing module with a single record access point.

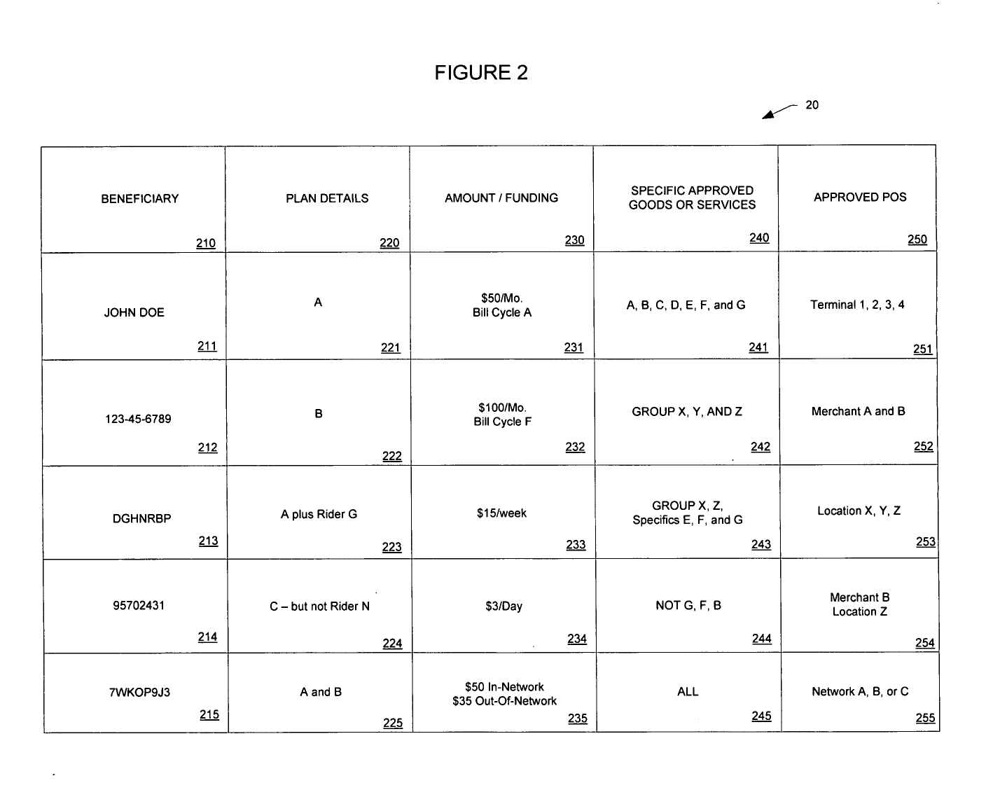

For example, FIG. 2 illustrates exemplary database entries 20 in accordance with some embodiments of the present invention. Database entries 20 set forth the beneficiary 210, health care plan details 220, the amount the beneficiary may access for spending on covered goods or services 230, specific approved goods or services (e.g., medications) 240, and POS devices or locations that are authorized to conduct transactions 250.

With continued reference to FIG. 2, it can be seen that beneficiaries may be identified by name (e.g., entry 211 “John Doe”), by social security number (e.g., entry 212 “123-45-6789”), by alphabetic characters (e.g., entry 213 “DGHNRBP”), by numeric characters (e.g., entry 214 “95702431”), or by alphanumeric characters (e.g., entry 215 “7WKOP9J3”). Plan details may be identified by an overall plan identifier (e.g, entry 221 “A” or entry 222 “B”), plan identifiers plus relevant riders (e.g., entry 223 “A plus rider G”), plan identifiers with particular carve-outs (e.g., entry 224 “C, but not rider N”), or by multiple plan identifiers (e.g., entry 225 “A and B”).

The amount of funding available for spending may be set forth monthly, weekly, or daily. The amount of funding may note which bill cycle is applicable, and may also note that the beneficiary has a set amount of funds to spend in-network and a different amount of funds to spend out-of-network. For example, entry 231 sets forth a $50.00/month funding, with bill cycle A. Entry 232 sets forth $100.00/month funding with bill cycle F. Entry 233 sets forth $15.00/week funding, while entry 234 sets forth $3/day funding. Entry 235 notes that $50.00/month is available for in-network coverage, while $35.00/month is available for out of network coverage.

The specific approved goods or services 240 may identify the approved goods or services individually (e.g., entry 241 “A, B, C, D, E, F, and G”), by group (e.g., entry 242 “Groups X, Y, and Z”), by a combination of groups and individually (e.g., entry 243 “Groups X, Z, Items E, F, and G”), specifically denied goods or services (e.g., entry 244 “NOT G, F, B”), or by making all goods or services available (e.g., entry 245, “All”).

Authorized POS devices or locations 250 may also be specified per beneficiary. Such authorization may be provided by specific terminal or device (e.g., entry 251 “Terminals 1, 2, 3, or 4”), by merchant (e.g., entry 252 “Merchant A or B”), by location (e.g., entry 253 “Location X, Y, or Z”), by any combination thereof (e.g., entry 254 “Merchant B, Location Z”), or by the communication network over which the transaction request was processed (e.g., entry 255 “Network A, B, or C”).

Tables of covered goods or services may be periodically changed or updated. If the tables or database records reside at the POS device or locations, the tables may be accessed by the health care provider or the processor. If the tables or database records reside at the processor, the tables may be accessed by the provider, either by granting the health care provider or POS device or location direct access to the database (i.e., allowing it to reach in to the processor's database), or via an API between the processor and the health care provider or POS device or location. Access may be triggered by queries of the health care provider or POS device or location. If the tables or records reside at the health care provider, such tables may be accessed in response to queries of the POS device or location or the processor.

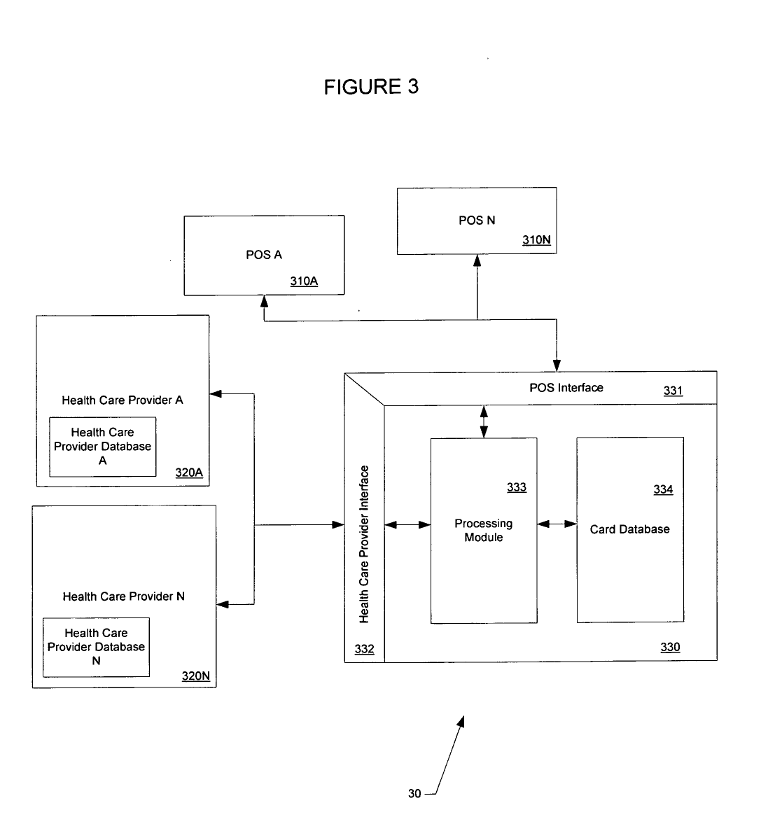

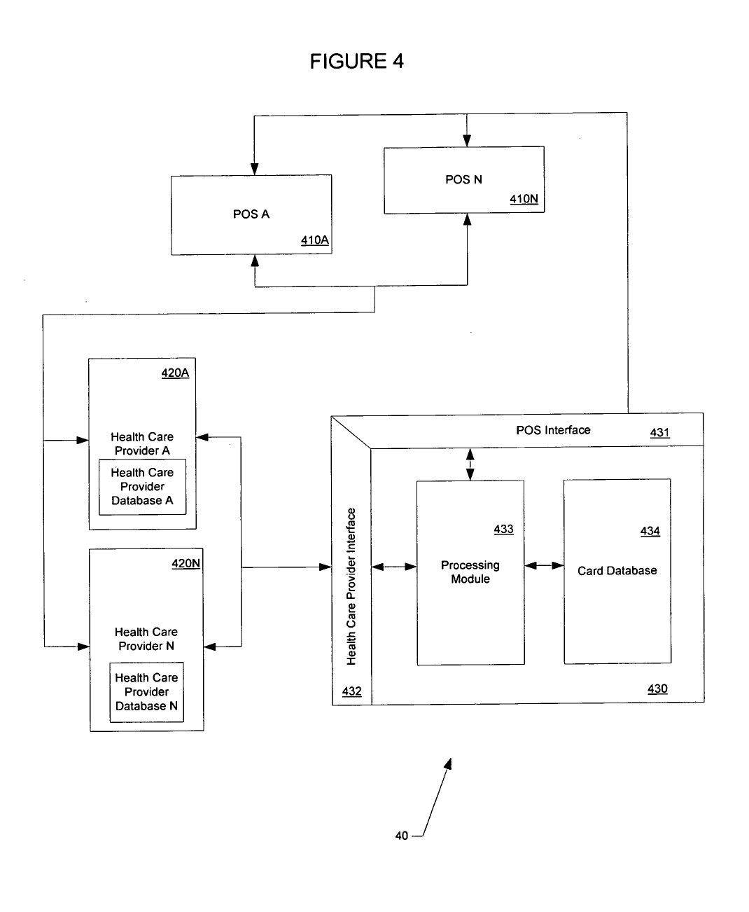

In some embodiments of the present invention, the health care provider may maintain the health care provider database. With reference to FIG. 3, the system 30 may be similar to that of FIG. 1, but the health care provider database 321A, 321N may reside at the health care provider itself\. In such embodiments, the processing module 333 may access the health care provider database 321A, 321N via the health care provider interface 332. In some embodiments, as illustrated in FIG. 4, the health care provider database may reside at the health care provider 420A, 420N, and may be accessed directly by the POS device or location 410A, 410N. In such embodiments, the processor 430, comprising a POS interface 431, health care provider interface 432, processing module 433, and card database 434 may primarily handle the financial side of purchase transactions—such as determining the amount of value associated with the stored value card, approving or declining transactions based on the available value, and decrementing the available value following purchase transactions.

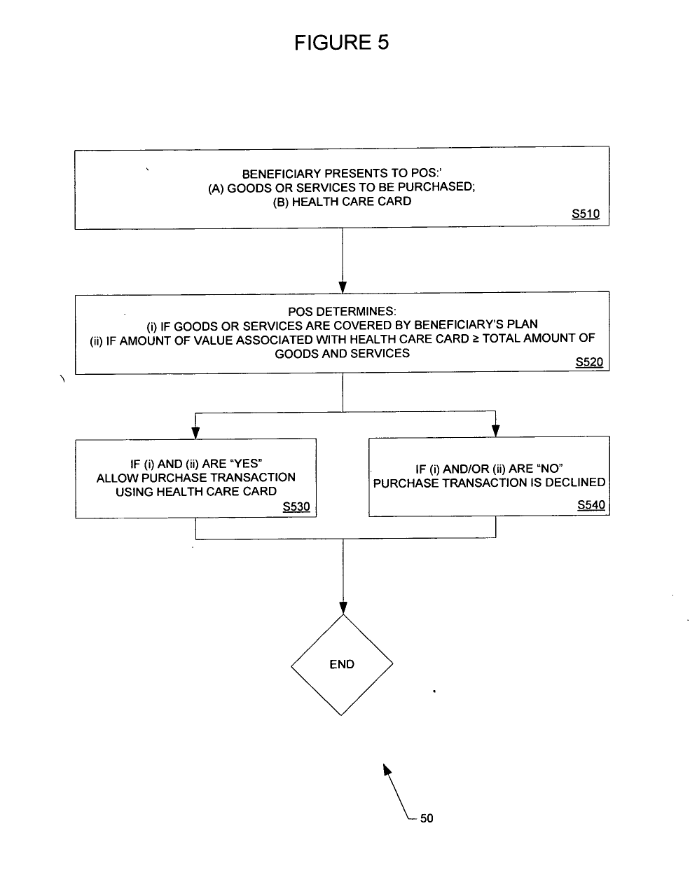

With reference to FIG. 5, a generalized method 50 of purchasing covered goods or services in accordance with the present invention will now be discussed. At S510, a beneficiary (or a representative of a beneficiary) may present to a POS device or location (a) goods or services to be purchased, and (b) the beneficiary's health care card. At S520 the POS device or location may determine (i) if the goods or services are covered by the beneficiary's plan, and (ii) if the amount of value associated with the beneficiary's health care card is greater than the total amount of the covered goods or services. This determination may be made with reference to various databases, as discussed above.

At S530, if determinations to (i) and (ii) are both “YES,” then the POS device or location may transact the purchase of the covered goods or services using the health care card. At S540, if determination (i) and/or (ii) are “NO,” then the POS device or location may decline to transact the purchase.

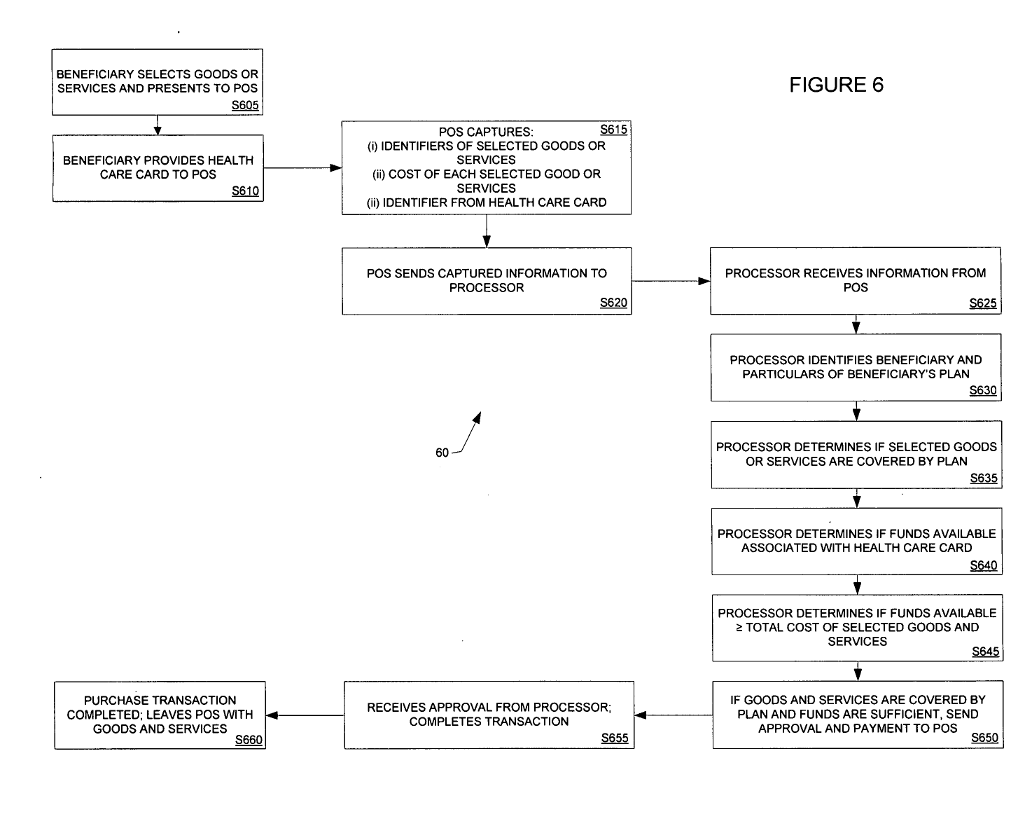

With reference to FIG. 6, a method 60 of purchasing goods or services with a health care card in accordance with some embodiments of the present invention will now be discussed. At S605 a beneficiary (or a representative of a beneficiary) selects goods or services and presents such goods or services to the POS device or location for purchase. At S610, the beneficiary (or a representative of the beneficiary) presents the beneficiary's health care card to the POS device or location.

At S615, the POS device or location captures or receives: (i) identifiers of the selected goods or services; (ii) the listed cost of the selected goods or services; and (iii) an identifier of the health care card. The listed cost of the selected goods or services may be determined by the POS device or location by reference to an applicable SKU table. At S620, the POS device or location may send the captured information to a processor.

At S625, the processor may receive the information from the POS device or location. At S630 the processor may, using the identifier of the health care card, identify the beneficiary and the particulars of the beneficiary's plan and coverage. At S635 the processor may determine if the selected goods or services are covered by the beneficiary's plan. At S640 the processor may determine the funds associated with the health care card, and at S645 the processor may determine if the funds associated with the health care card are greater than or equal to the total cost of the selected goods or services. If the selected goods or services are covered by the beneficiary's plan, and there is sufficient value associated with the health care card, the processor may send approval and payment to the POS device or location at S650.

At S655 the POS device or location may receive approval and payment from the processor, and may complete the purchase transaction.

At S660, the purchase transaction is complete; the beneficiary (or representative of the beneficiary) may leave the POS device or location with the purchased goods or services.

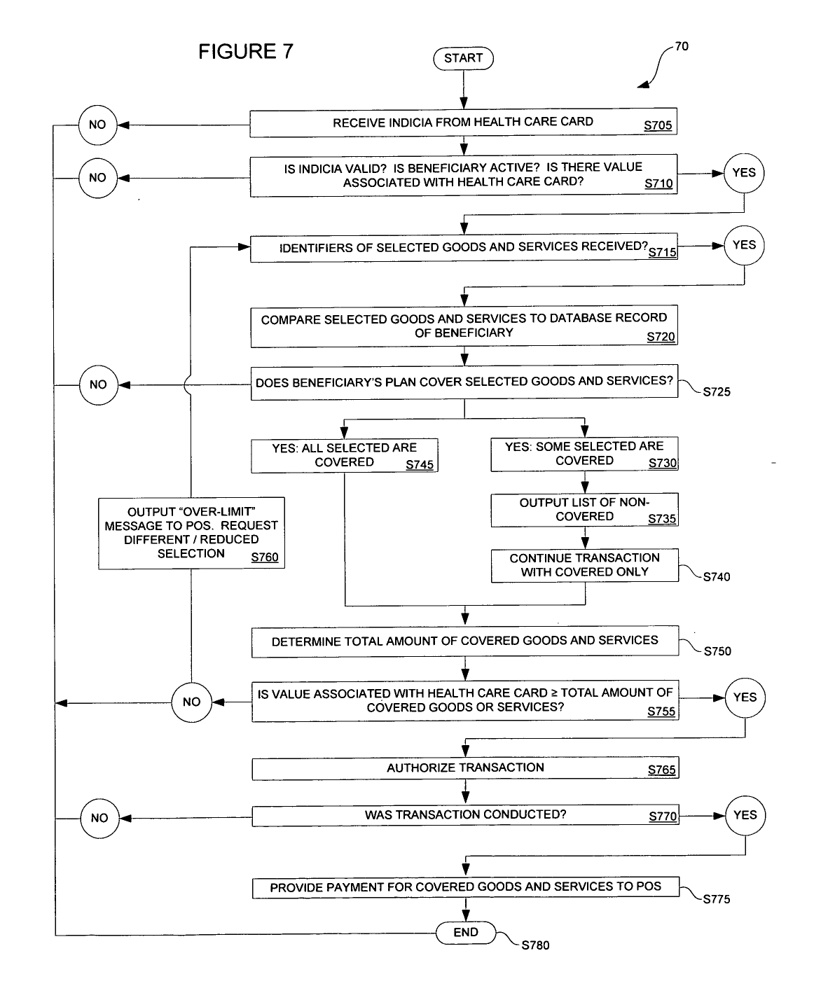

Another exemplary method 70 of conducting a purchase transaction of goods or services in accordance with some embodiments of the present invention is depicted in FIG. 7. FIG. 7 illustrates the steps that a processor may perform in conducting such a method.

At S705 the processor may receive an indicia from a health care card. At S710, the processor may determine (i) whether the indicia is valid (e.g., by verifying a checksum); (ii) whether the beneficiary is active; and (iii) whether there is any value associated with the health care card. If the determination of any of (i), (ii), or (iii) is negative, then the transaction terminates at S780.

If the determination of (i), (ii), and (iii) is positive, then the transaction continues to S715, at which point the processor may receive identifiers of selected goods or services for purchase. Once the identifiers of the selected goods or services are received, the processor may compare the selected goods or services to goods or services that are covered by the beneficiary's plan at S720. At S725, the processor determines if the beneficiary's plan covers the selected goods or services. If the beneficiary's plan does not cover any of the selected goods or services, the transaction terminates at S780. If all of the selected goods or services are covered by the beneficiary's plan (determined at S745) the process continues to S750.

If the beneficiary's plan covers at least some of the selected goods or services (determined at S730), then the processor may output a list of the goods or services that are not covered to the POS device or location at S735. The transaction may continue at S740 with only the goods or services covered by the plan, and may continue to S750.

At S750, the processor may determine the total amount due for the goods or services covered by the beneficiary's plan. At S755, the processor may determine if the value associated with the health care card is greater than or equal to the total amount due. If the value associated with the health care card is less than the total amount due, the processor may output, at S760, an “over-limit” message to the POS device or location, requesting a different or reduced selection of goods or services. If a different or reduced selection is presented to the POS device or location, the process may return to S715.

If the value associated with the health care card is greater than or equal to the total amount due, at S765 the processor may authorize the transaction. At S770 the processor may determine if the transaction was conducted, and if so at S775 the processor may provide payment (i.e., settlement) with the POS device or location. If the transaction was not conducted, then the transaction may terminate at S780.

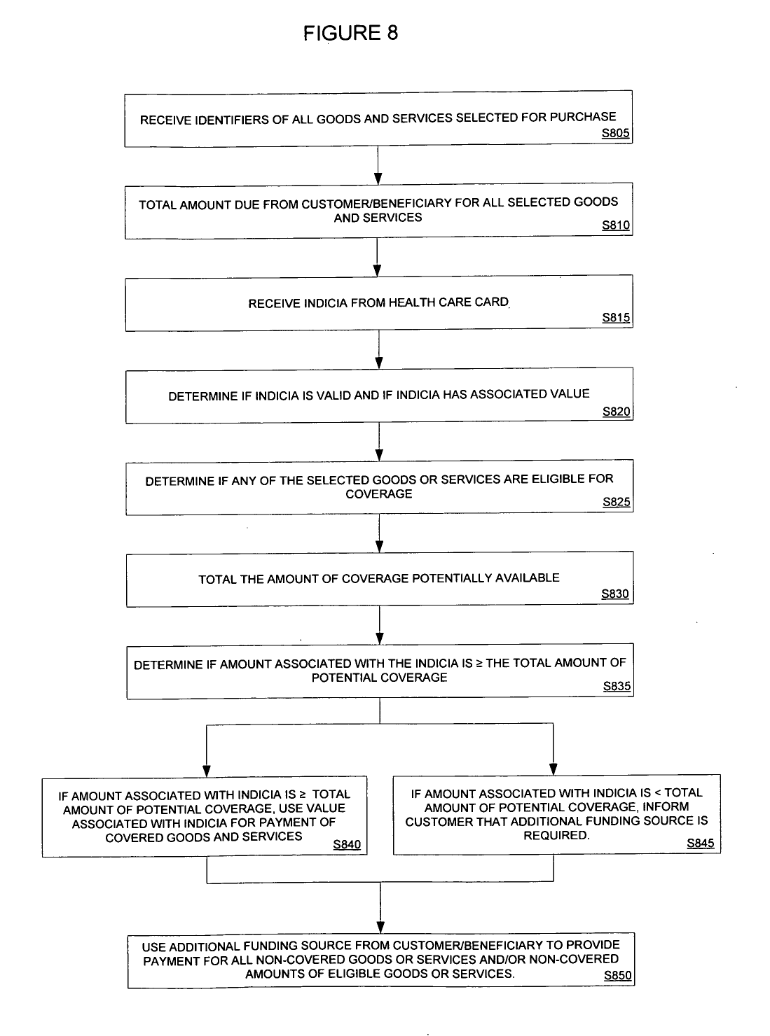

With reference to FIG. 8, a method 80 of conducting a purchase transaction of both covered and non-covered goods or services, in accordance with the present invention, will now be discussed. At S805 a POS device or location may receive identifiers of all goods or services selected for purchase. At S810 the total amount due from the customer for all selected goods or services may be calculated. At S815, the POS device or location may receive an indicia from a health care card, identifying the health care card. The POS device or location may then determine if the indicia is valid and has associated value at S820.

At S825, the POS device or location may determine if any of the selected goods or services are eligible for coverage from the customer's (or another's) health care provider (or HSA account). At S830, the total amount of contribution potentially available from the health care provider (or HSA account) may be calculated. For example, if a customer selects goods A, B, and C, coverage of A may be limited to $5, coverage of B may be limited to $10, and coverage of C may be limited to $20. Therefore, the total amount of coverage potentially available is $35. At S835, it is determined if the amount of value associated with the indicia is greater than or equal to the total amount of coverage potentially available. If the amount associated with the health care card is greater than or equal to the total amount of coverage potentially available, the POS device or location may use the value associated with the health care card for payment of the covered goods or services at S840.

If the amount associated with the health care card is less than the total amount of coverage potentially available, then the POS device or location may inform the customer that an additional funding source is required for the deficit at S845.

At S850, the POS device or location may request and use an additional funding source from the customer to provide payment for (i) all non-covered goods or services; and/or (ii) non-covered amounts of eligible goods or services.

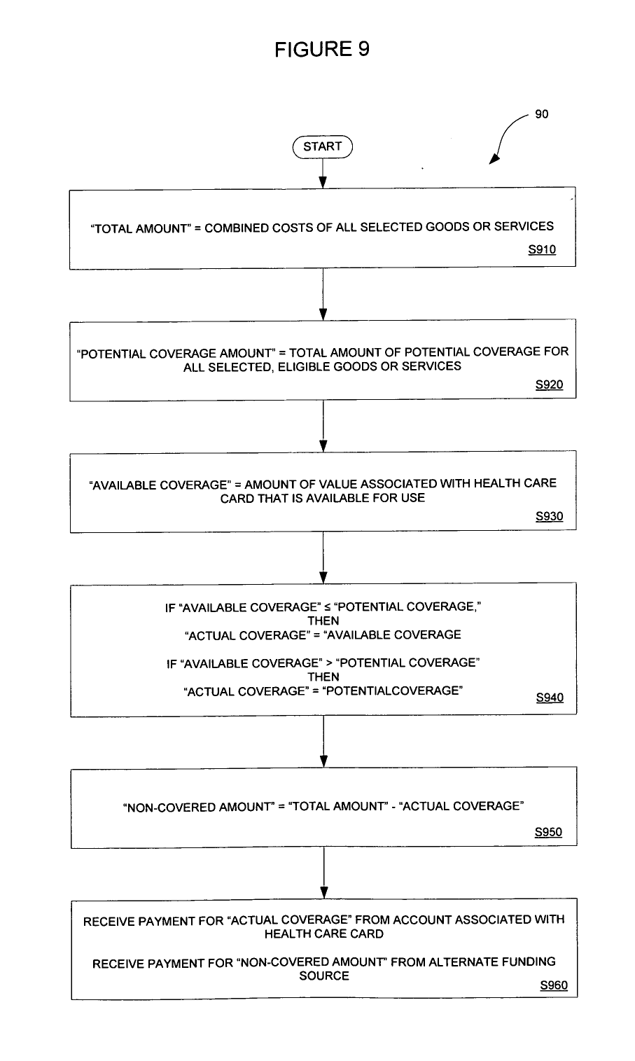

With reference to FIG. 9, an exemplary method 90 of receiving partial payment for covered goods or service and partial payment for non-covered goods or services (or non-covered amounts of otherwise eligible goods or services) will now be discussed.

At S910, all selected goods or services are totaled, creating a “TOTAL AMOUNT.”

At S920, the total amount of potential coverage for eligible goods or services is determined, creating a “POTENTIAL COVERAGE AMOUNT.”

At S930, the total amount of value available for coverage (e.g., associated with a health care card) is determined, creating an “AVAILABLE COVERAGE.”

At S940, an “ACUTAL COVERAGE” is calculated as follows: (1) If the “AVAILABLE COVERAGE” is ≦“POTENTIAL COVERAGE,” then “ACTUAL COVERAGE”=“AVAILABLE COVERAGE.”

(2) If the “AVAILABLE COVERAGE” is >“POTENTIAL COVERAGE,” then “ACTUAL COVERAGE”=“POTENTIAL COVERAGE.”

At S950, the total “NON-COVERED AMOUNT” is determined, where “NON-COVERED AMOUNT”=“TOTAL AMOUNT”−“ACTUAL COVERAGE.”

At S960, payment is received for the “ACTUAL COVERAGE” from the value associated with the health care card. Payment for the “NON-COVERED AMOUNT” is received from an alternate funding source.

Many deviations, additions, and omissions from the above-discussed systems and methods may be present without deviating from the scope of the present invention. For example, the POS device or location may inform the beneficiary (or representative of the beneficiary) of non-covered goods or services that were selected for purchase. The beneficiary (or representative of the beneficiary) may also be informed of coverage limits per selected goods or services, or the total amount available for use. The POS device or location may inform the beneficiary (or representative of the beneficiary) that while a particular brand of a good or service was selected, it is not covered while an alternative brand is covered. The POS device or location may determine the information above through its own processing, or may make such determination based upon information sent to and received from a processor and/or health care provider.

The amount of coverage available from a HSA may vary depending upon the merchant or retailer from whom the goods or services are purchased. For example, coverage of item X may be $10 at Retailer A, but may be only $5 at Retailer B.

Coverage—or other promotional benefits—may also be tied to specific goods or services, or specific combinations of goods or services. For example, available coverage for a men's multivitamin may be $5, while coverage for a women's multivitamin—in the same purchase transaction—may be raised to $7.50. Or the selection of three (3) or more products from manufacturer XYZ may result in an additional 10% of coverage—or a 10% reduction in price—of additional products from manufacturer XYZ. Accordingly, in this manner, there may be a union between health care plan coverage and promotional attributes.

The above-disclosed invention discusses the use of a filter card specific for health care purchases. However, the systems and methods discussed above may be implemented and employed for the purchase of any subset of goods or services. For example, rather than a “health care card,” and a “beneficiary,” a “membership card” and a “member” may exist. The membership card may entitle the member to contributions for specific goods or services from an account associated with the membership card. The account may be funded by a third party—for example an organization interested in promoting particular purchases. For example, stored value cards may be issued to students and the value may only be used to purchase school supplies.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

What is claimed is:

1. A method of conducting a purchase transaction of goods or services, the goods or services which may comprise eligible goods or services, the purchase transaction funded at least in part by a stored value associated with an indicia presented by a purchaser at a point-of-sale, the stored value being redeemable towards the purchase of the eligible goods or services, the method comprising:
receiving at a point-of-sale:
identifiers of goods or services selected for purchase; and
the indicia associated with a stored value;
determining if the goods or services selected for purchase comprise eligible goods or services;
totaling the amount required for the purchase of the eligible goods or services;
determining if the stored value associated with the indicia is sufficient for purchase of the eligible goods or services;
upon positive determinations that the goods or services comprise eligible goods or services and that the stored value is sufficient for purchase of the eligible goods or services, using the stored value towards the purchase of the eligible goods or services; and
using an additional funding source provided by the purchaser towards the purchase of any goods or services that are not eligible goods or services.

2. The method of claim 1, wherein the stored value is inaccessible by the purchaser other than for the purchase of eligible goods or services.

3. The method of claim 1, wherein the indicia associated with a stored value is a machine readable format.

4. The method of claim 3, wherein the machine readable format is selected from the group consisting of: a magnetic stripe, a bar code, a radio frequency identification (RFID) tag, and a micro-dot.

5. The method of claim 1, wherein the step of determining if the goods or services selected for purchase comprise eligible goods or services comprises:
accessing a database of eligible goods or services; and
comparing the identifiers of the goods or services selected for purchase to the database of eligible goods or services.

6. The method of claim 5, wherein the database of eligible goods or services is not maintained by the point-of-sale.

7. The method of claim 1, wherein the step of determining if the stored value associated with the indicia is sufficient for purchase of the eligible goods or services comprises:
accessing a database comprising records related to the indicia;
determining the value associated with the indicia; and
comparing the value associated with the indicia to the total amount required for the purchase of the eligible goods or services, and if the stored value associated with the indicia is greater than or equal to the total amount required for the purchase of the eligible goods or services, determining that the stored value associated with the indicia is sufficient.

8. The method of claim 1, wherein the step of using the stored value towards the purchase of the eligible goods or services comprises:
communicating with a party that maintains an account that holds the stored value associated with an indicia and requesting payment in an amount equal to the total amount required for the purchase of the eligible goods or services.

9. A method of conducting a purchase transaction of goods or services, the goods or services which may comprise eligible goods or services, the purchase transaction funded at least in part by a stored value associated with an indicia presented by a purchaser at a point-of-sale, the stored value being redeemable towards the purchase of the eligible goods or services, the method being conducted by a computerized processor and comprising:
receiving the indicia from the point-of-sale;
accessing database records associated with the indicia, the database records comprising eligible goods or services for the indicia and the amount of value associated with the indicia;
receiving identifiers of goods or services selected for purchase;
determining if the goods or services selected for purchase comprise eligible goods or services;
determining a total amount of value required for the purchase of the eligible goods or services;
if the amount of value associated with the indicia is less than the total amount of value required for the purchase of the eligible goods or services, informing point-of-sale of the deficiency and authorizing the purchase transaction for the amount of value associated with the indicia;
if the amount of value associated with the indicia is greater than or equal to the total amount of value required for the purchase of the eligible goods or services, authorizing the purchase transaction for the total amount of value required to purchase the eligible goods or services;
following confirmation of the purchase transaction, reducing the amount of value associated with the indicia by the amount of value used in the purchase transaction.

10. The method of claim 9, wherein the stored value is inaccessible by the purchaser other than for the purchase of eligible goods or services.

11. The method of claim 9, further comprising the step of:
determining if the indicia is valid.

12. The method of claim 9, wherein the database records associated with the indicia further comprising authorized point-of-sale devices or locations for conducting purchase transactions using the indicia.

13. The method of claim 9, wherein the step of determining if the goods or services selected for purchase comprise eligible goods or services comprises:
comparing the identifiers of the goods or services selected for purchase with the database records associated with the indicia.

14. The method of claim 9, wherein the step of determining a total amount of value required for the purchase of the eligible goods or services comprises:
receiving purchase price for each eligible goods or service from the point-of-sale; and
totaling the purchase prices for each eligible goods or service.

15. A computerized processor system for conducting a purchase transaction of goods or services facilitated, the goods or services which may comprise eligible goods or services, the purchase transaction funded at least in part by a stored value associated with an indicia presented by a purchaser at a point-of-sale, the stored value being redeemable towards the purchase of the eligible goods or services, the computerized processor system comprising:
a point-of-sale communication interface that provides selectable communication between the processor system and the point-of-sale, the point-of-sale interface configured to receive from the point-of-sale:
the indicia presented by the purchaser at the point-of-sale; and
identifiers of goods or services selected for purchase;
a provider communication interface that provides selectable communication between the processor system and a provider, the provider determining which goods or services qualify as eligible goods or services, the provider communication interface configured to receive from the provider:
information sufficient to identify goods or services that qualify as eligible goods or services;
a database comprising records for each indicia, the records comprising value information pertaining to the value associated with the indicia; and
a procesing module, the processing module coupled to the point-of-sale interface, provider communication interface, and database, the processing module configured to:
determine if the goods or services selected for purchase comprise eligible goods or services;
total the amount required for the purchase of the eligible goods or services;
determine if the stored value associated with the indicia is sufficient for purchase of the eligible goods or services; and
upon positive determinations that the goods or services comprise eligible goods or services and that the stored value is sufficient for purchase of the eligible goods or services, provide the stored value to the point-of-sale towards the purchase of the eligible goods or services.

16. The computerized processor system of claim 15, wherein records for each indicia further comprise:
information sufficient to identify point-of-sale devices or locations authorized to conduct purchase transactions using the indicia and value associated with the indicia.

17. The computerized processor system of claim 15, wherein the records for each indicia further comprise:
information sufficient to determine eligible goods or services for each indicia.

18. The computerized processor system of claim 15, wherein the processing module is configured to determine if the goods or services selected for purchase, comprise eligible goods or services by comparing the received identifiers of the goods or services to a listing of eligible goods or services specific to each indicia.

19. The computerized processor system of claim 18, wherein the listing of eligible goods or services specific to each indicia is provided by the provider, and may be periodically updated by the provider.

20. The computerized processor system of claim 15, wherein:
the provider is a health care provider; and
the value associated with the indicia is provided by the health care provider substantially for the purchase of goods or services related to health care.
